(19) United States
(12) Patent Application Publication
(10) Pub. No.: US 2008/0048628 A1
(43) Pub. Date: Feb. 28, 2008

(54) Voltage converter and a method of using the same

(76) Inventor: Yong-Hee Lee, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/889,776

(22) Filed: Aug. 16, 2007

(30) Foreign Application Priority Data
Aug. 22, 2006 (KR) 10-2006-0079447

(51) Int. Cl. G05F 1/44; G05F 1/10

(52) U.S. Cl. 323/271; 323/283

(57) ABSTRACT

Example embodiments relate to a voltage converter having a power switching unit, an analog-digital converting (ADC) unit, a digital low pass filter (LPF), an error value (EV) calculator, and a switching signal generator. The power switching unit may generate an output voltage by switching between an output terminal and one of the power voltage and the ground voltage in response to a switching signal. The ADC unit may output a converted power level signal and a converted output level signal. The EV calculator may generate an EV by comparing a low pass filtered power level signal and a low pass filtered output level signal output from the digital LPF, and an output set value. The switching signal generator may generate the switching signal for adjusting a time interval during which the output terminal is connected to one of the power voltage and the ground voltage.

### BACKGROUND OF THE INVENTION

1. Field of the Invention

Example embodiments relate to a voltage converter, and more particularly, to a DC-DC converter of a switching regulator type.

2. Description of the Related Art

A DC-DC converter generally refers to a circuit for converting a DC voltage to another DC voltage having a different voltage level. The DC-DC converter may also provide a DC voltage selected by a user. The DC-DC converter may also be used for maintaining a constant voltage, in which the DC-DC converter may have a structure which may feedback an output voltage and compare the set voltage with the output voltage.

A switching regulator may be one type of a DC-DC converter. The switching regulator may compare an output voltage with a set voltage. A pulse width modulation signal may then be generated from an error between the output voltage and set voltage. A PMOS power transistor and an NMOS transistor, which may be serially coupled and controlled by the pulse width signal, may generate the output voltage.

A conventional switching regulator may include a power switch unit, a low pass filter, an error amplifier and an analog pulse modulator. The switching regulator may also include a sigma delta modulator and a gate driver, instead of the analog pulse width modulator.

The error amplifier and the sigma delta modulator included in the switching regulator may be implemented with an analog circuit or a digital circuit. When the error amplifier is implemented with the analog circuit, the error amplifier may receive the output voltage Vout and the set voltage Vset as analog values. The error value may also correspond to an analog value. The sigma delta modulator may be implemented with an analog circuit, and the sigma delta modulator may be generated according to the error value EV. When the error amplifier is implemented with the digital circuit, the output voltage Vout and the set voltage may be converted to digital values. A digital value corresponding to the error value EV may then be output by comparing the output voltage Vout with the set voltage Vset. The sigma delta modulator may also be implemented with a digital circuit.

Regardless of whether the switching regulator is implemented with the analog circuit or the digital circuit, the switching regulator may receive the output voltage Vout as a feedback. Thus, a switching noise component remaining in the output voltage Vout, a variation of the output voltage Vout according to a variation of a load, a noise component due to a harmonic and self modulation, may influence the error value EV. A variation of the power voltage VDD may also influence the output voltage Vout of the switching regulator.

### SUMMARY OF THE INVENTION

Example embodiments are therefore directed to a voltage converter and method thereof, which substantially overcome one or more of the problems due to the limitations and disadvantages of the related art.

It is therefore a feature of example embodiments to provide a DC-DC converter that may compensate a variation of a power voltage.

It is therefore another feature of example embodiments to reduce noise caused by a switching operation.

It is therefore yet another feature of example embodiments to increase a degree of integration by replacing a conventional analog circuit with a digital circuit.

It is therefore yet another feature of example embodiments to provide a method of converting a DC-DC converter that may compensate a variation of a power voltage and reduce noise.

At least one of the above and other features of example embodiments may provide a voltage converter, having a power switching unit, an analog-digital converting unit, a digital low pass filter, an error value calculator, and a switching signal generator. The power switching unit may be configured to receive a power voltage and a ground voltage, and may be configured to generate an output voltage by switching between an output terminal and one of the power voltage and the ground voltage in response to a switching signal. The analog-digital converting unit may be configured to output a converted power level signal and a converted output level signal by sampling the power voltage, the output voltage, the converted power level signal and the converted output level signal corresponding to digital signals. The digital low pass filter may be configured to perform low pass filtering on the converted power level signal and the converted output level signal. The error value calculator may be configured to generate an error value by comparing the low pass filtered power level signal, the low pass filtered output level signal and an output set value. The switching signal generator may be configured to generate the switching signal for adjusting an time interval of connecting the output terminal to the one of the power voltage and the ground voltage.

The error value calculator may output a difference value between the output set value and a sum of a first compensation value and a second compensation value, the first compensation value corresponding to a multiplied value of the low pass filtered power level signal and a first gain factor, and the second compensation value corresponding to a multiplied value of the low pass filtered output level signal and a second gain factor.

The error value calculator may include a first multiplier configured to output the first compensation signal by multiplying the low pass filtered power level signal and the first gain factor, a second multiplier configured to output the second compensation signal by multiplying the low pass filtered output level signal and the second gain factor, and a subtractor configured to output the difference value between the output set value and the sum of the first compensation value and the second compensation value.

The error value calculator may output a difference value between the output set value and a sum of the first compensation value, the second compensation value and an offset value of an entire system.

The error value calculator may include a first multiplier configured to output the first compensation signal by multiplying the low pass filtered power level signal and the first gain factor, a second multiplier configured to output the second compensation signal by multiplying the low pass filtered output level signal and the second gain factor, and a subtractor configured to output the difference value between the output set value and the sum of the first compensation value, the second compensation value and the offset value.

The power switching unit may include a PMOS power transistor and an NMOS power transistor serially coupled between the power voltage and the ground voltage, and gate terminals of the PMOS power transistor and the NMOS power transistor configured to receive the switching signal.

The analog-digital converting unit may include an analog sigma delta modulator.

The switching signal generator may be configured to generate the switching signal, so that a pulse width of the switching signal may be determined based on the error value.

The switching signal generator may include a digital multi-bit sigma delta modulator configured to modulate the error value into a pulse code modulation signal having a reduced number of bits, and a pulse width modulator for generating the switching signal, so that a pulse width of the switching signal may be determined based on the pulse code modulation signal.

The voltage converter may be a DC-DC converter.

At least one of the above and other features of example embodiments may provide a method of converting voltage. The method may include generating an output voltage from a power voltage and a ground voltage by switching between an output terminal and one of the power voltage and the ground voltage in response to a switching signal, generating a power level signal and an output level signal by sampling the power voltage and the output voltage, performing low pass filtering on the power level signal and the output level signal, generating an error value by comparing the low pass filtered power level signal, the low pass filtered output level signal and an output set value, and generating the switching signal by adjusting an time interval of connecting an output terminal to one of the power voltage and the ground voltage.

### BRIEF DESCRIPTION OF THE DRAWINGS

The above and other features and advantages of the example embodiments will become more apparent to those of ordinary skill in the art by describing in detail example embodiments thereof with reference to the attached drawings, in which:

FIG. 1 illustrates a block diagram of a DC-DC converter according to an example embodiment;

FIG. 2 illustrates a block diagram of an error value calculator in FIG. 1; and

FIG. 3 illustrates a diagram of a result of simulating the DC-DC converter according to an example embodiment.

### DESCRIPTION OF THE INVENTION

Korean Patent Application No. 2006-79447, filed on Aug. 22, 2006 in the Korean Intellectual Property Office, and entitled: “DC-DC Converter and Method of DC-DC Conversion for Compensating Variation of Power Voltage,” is incorporated herein in its entirety by reference.

Example embodiments will now be described more fully hereinafter with reference to the accompanying drawings. The invention may, however, be embodied in different forms and should not be construed as limited to the embodiments set forth herein. Rather, these example embodiments are provided so that this disclosure will be thorough and complete, and will fully convey the scope of the invention to those skilled in the art.

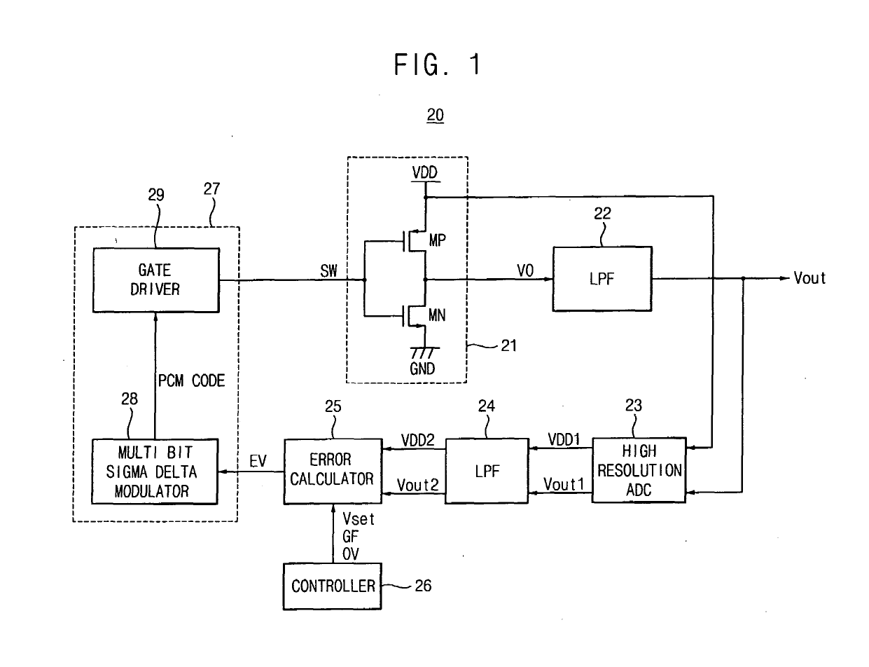

FIG. 1 illustrates a block diagram of a DC-DC converter 20 according to an example embodiment.

Referring to FIG. 1, the DC-DC converter 20 may include a power switching unit 21, a first low pass filter 22, a high resolution analog-to-digital converter (ADC) 23, a second low pass filter 24, an error value calculator 25, a controller 26, and a switching signal generator 27. It should be appreciated that other devices and/or components may be incorporated in the DC-DC converter 20.

The power switching unit 21 may include a PMOS transistor MP and an NMOS transistor MN serially coupled between a power voltage VDD and a ground voltage GND. A switching signal SW may be provided to gates of the PMOS transistor MP and NMOS transistor MN. One of the PMOS transistor MP and the NMOS transistor MN may be turned on according to a pulse width of the switching signal SW. A drain terminal of PMOS transistor MP may be coupled to a drain terminal of NMOS transistor MN, and an output signal VO having a ripple may output at the coupled drain terminals.

The first low pass filter 22 may filter the output signal VO including the ripple, and may output an output voltage Vout of direct current (DC) level. The ripple of the output signal VO may be eliminated by the low pass filter 22. The low pass filter 22 may be implemented with a passive element, for example.

The high resolution ADC 23 may convert the output voltage Vout and the power voltage VDD into an output level signal Vout1 and a power level signal VDD1, respectively. The converted output level signal Vout1 and the converted power level signal VDD1 may be digital signals, for example. The high resolution ADC 23 may be operated with a high resolution for precisely detecting an error value. A converting speed of the high resolution ADC 23 may be, for example, approximately two or three times higher than an operating frequency of the switching signal SW. The high resolution ADC 23 may be implemented with a 1-bit analog sigma delta modulator, for example. The high resolution ADC 23 may produce, such as, but not limited to, a low power dissipation, a high resolution and/or a noise shaping. Thus, the analog sigma delta modulator may be suitable for modulating a low frequency.

The high resolution ADC 23 may be implemented with a single ADC for alternately converting the output voltage Vout and the power voltage VDD. Alternatively, the high resolution ADC 23 may also be implemented with two or more ADCs located in parallel for respectively converting the output voltage Vout and the power voltage VDD into digital signals.

The second low pass filter 24 may perform low pass filtering on the digital signals output from the high resolution ADC 23, e.g., the output level signal Vout1 and the power level signal VDD1. The second low pass filter 24 may correspond to a digital filter for converting a digital signal. The digital filter may precisely cut off a frequency regardless of an integration degree of elements. The second low pass filter 24 may be implemented with a cascode integration comb (CIC) low pass filter, for example. By implementing the CIC low pass filter, an out-of-band noise component (which may be generated by oversampling in the ADC 23), a thermal noise (which may be generated in an entire system), and a switching noise component of the power switching unit 21, may prevent and/or reduce influencing the entire system. For example, a high frequency noise may be reduced by converting a pulse density modulation (PDM) signal output from the 1-bit sigma delta modulator into a pulse code modulation (PCM) signal by the CIC filter. Each element may be required to have a structure to reduce noise, due to a characteristic of a feedback circuit that may become more stable as the noise decreases.

The error value calculator 25 may output an error value EV corresponding to a digital signal by comparing the power level signal VDD2 and the output level signal Vout2 with the output voltage set value Vset, in which the noise of the output level signal Vout2 may be reduced through the second low pass filter 24. The output voltage set value Vset may be set to a high resolution because the digital output level signal Vout2 may also be set to a high resolution. As a result, the error value EV may be generated.

The controller 26 may provide the output voltage set value Vset, a gain factor GF, and an offset value OV to the error value calculator 25. The output voltage set value Vset, the gain factor GF, and the offset value OV may each be set by a user and/or may be set automatically.

The switching signal generator 27 may receive the error value EV corresponding to the high resolution digital signal, and may generate the switching signal SW. The switching signal generator 27 may include a digital sigma delta modulator 28 and pulse width modulation signal generator 29, e.g., a gate driver. When the digital sigma delta modulator 28 is used, a noise shaping technique (e.g., a characteristic of a sigma delta modulation) may be utilized. In other words, the digital sigma delta modulator 28 may reduce an in-band noise due to a noise shaping characteristic. Accordingly, an analog low pass filter or digital low pass filter may be used to prevent and/or reduce the possibility of increasing out-of-band noise. Further, the digital sigma delta modulator 28 may be implemented to have a low order structure when providing stability, speed dissipation and power dissipation. The digital sigma delta modulator 28 may generate a multi-bit pulse code modulation (PCM) signal. The multi-bit PCM signal may be converted to the switching signal SW via the pulse width modulation signal generator 29. The switching signal SW may be a PWM signal type, for example.

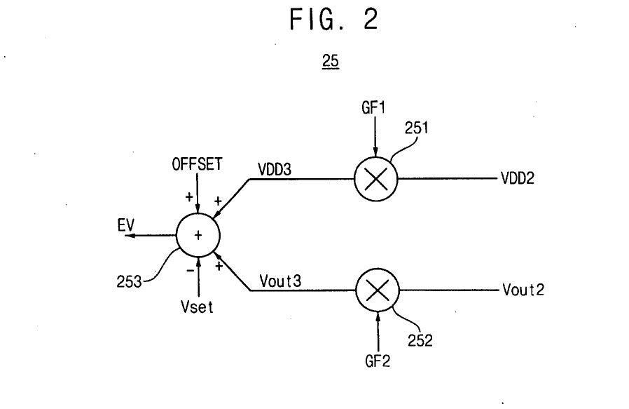

FIG. 2 illustrates a block diagram of the error value calculator 25 in FIG. 1.

Referring to FIG. 2, the error value calculator 25 may include a first multiplier 251, a second multiplier 252, and a subtractor 253. The first multiplier 251 may output a first compensation signal VDD3 corresponding to a multiplied value of the power level signal VDD2 and a first gain factor GF1. The second multiplier 252 may output a second compensation signal corresponding to a multiplied value of the output level signal Vout2 and a second gain factor GF2. The subtractor 253 may output an error value EV corresponding to the first compensation signal VDD3 plus the second compensation signal Vout3 minus the output voltage set value Vset.

Hereinafter, an operation of the error value calculator 25 will be described in detail.

The power level signal VDD2 may be obtained by sampling a level of a voltage provided to the power switch unit 21 in real-time. Thus, the time variation of the power voltage VDD may be reflected into the sampled signal. For example, an increase or a decrease in the power voltage level provided by a battery, for example, may be reflected by sampling the power voltage VDD. The first gain factor GF1 may be a gain factor for compensating a variation of the power voltage VDD level. The first gain factor GF1 may be set automatically according to a detected power voltage level VDD1. Alternatively, the first gain factor GF1 may be set externally by a user.

The output level signal Vout2 may be obtained by sampling the output voltage Vout in real-time. Thus, the time variation of the output voltage Vout may also be reflected into the sampled signal when the output voltage Vout changes according to the user's setting or an operation of a system receiving the output voltage Vout. The second gain factor GF2 may be a gain factor for reflecting a variation of a set value of the output voltage Vout. The second gain factor GF2 may also be determined based on the output voltage set value Vset. The second gain factor GF2 may be set automatically, or may be set externally by a user.

The power level signal VDD2 and the output level signal Vout2 may be provided to the subtractor 253 after being scaled by the first gain factor GF1 and the second gain factor GF2, respectively. The subtractor 253 may output the error value EV by subtracting the output voltage set value Vset from a sum of the first compensation signal VDD3 and the second compensation signal Vout3.

In an example embodiment, the subtracted value may not correspond to an exact difference between a level of the output voltage Vout and the output voltage set value Vset. The subtracted value, however, may reflect a difference between a level of the output voltage Vout and the output voltage set value Vset. The output voltage Vout may be determined by a current dissipated by an entire system load and a current provided from the power switch unit 21. Thus, the error value EV may be directly related to a duty ratio of a pulse width of the switching signal SW driving the power switch unit 21.

When the power switch unit 21 needs to provide more current to a load for maintaining the output voltage Vout, the error value EV may need to be increased.

Conversely, when the power switch unit 21 needs to provide less current to a load for maintaining the output voltage Vout, the error value EV may need to be decreased. Accordingly, a range of the error value EV may correspond to a range of the pulse width of the switching signal SW. Thus, a difference between the output voltage set value Vset and a measured value of the power voltage may not be used as the error value EV.

In another example embodiment, the first compensation signal VDD3 and the second compensation signal Vout3 may be generated by compensating a measured value of the output voltage Vout1 and the power voltage VDD1. A difference between the output voltage set value and a sum of the first compensation signal VDD3 and the second compensation signal Vout3 may then be calculated as the error value EV.

Further, the offset value OV may be provided to the subtractor 253 from the controller 26 for reflecting an influence of the output voltage Vout via an offset that the entire system may encompass.

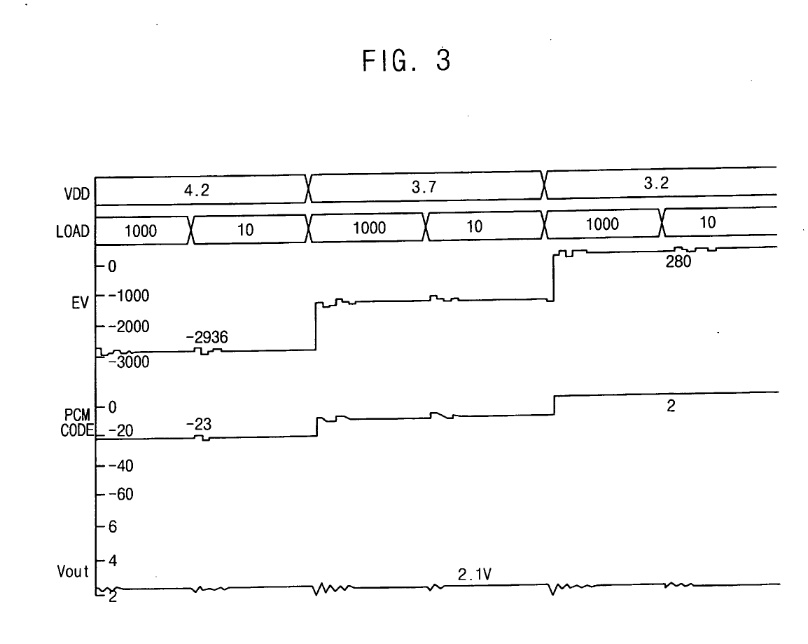

FIG. 3 illustrates a diagram of a result of simulating the DC-DC converter 20 according to an example embodiment.

Referring to FIG. 3, the power voltage VDD may be initially approximately 4.2V. The power voltage VDD may be decreased to approximately 3.7V, then approximately 3.2V, according to an elapse of time. The output voltage Vout may correspond to approximately 2.1V. A load of the system, in which the output voltage Vout may be provided, may change to approximately 10 ohm or approximately 1000 ohm according to an elapse of time. The output voltage Vout, the power level signal VDD and the error value EV may correspond to a 14-bit quantized digital code having 16,384 steps from, e.g., −8192 to +8191. The digital sigma delta modulator 28 may receive the 14-bits error value, and may modulate the error value EV. The digital sigma delta modulator 28 (shown in FIG. 1) may then output a 7-bit PCM code. The 7-bit PCM code may have 128 steps from, e.g., −64 to +63.

Further, when the power voltage VDD corresponds to approximately 4.2V, the error value EV may correspond to approximately −2940, and the PCM code may correspond to approximately −23. When the power voltage VDD decreases to approximately 3.7V, the error value EV may increase to approximately −1250, and the PCM code may increase to approximately −10. When the power voltage VDD decreases to approximately 3.2V, the error value EV may increase to approximately 280, and the PCM code may increase to approximately 2. The output voltage Vout may be maintained constantly at approximately 2.1V in spite of a variation of the power voltage VDD.

In example embodiments, the DC-DC converter may provide a stable output voltage in spite of a variation of the power voltage. Further, noise caused by a switching operation may be reduced, an integration degree may be increased by replacing a conventional analog circuit with a digital circuit, and power dissipation may be reduced.

It will be understood that, although the terms “first” and “second” etc. may be used herein to describe various elements, structures, components, regions, layers and/or sections, these elements, structures, components, regions, layers and/or sections should not be limited by these terms. These terms are only used to distinguish one element, structure, component, region, layer and/or section from another element, structure, component, region, layer and/or section. Thus, a first element, structure, component, region, layer or section discussed below could be termed a second element, structure, component, region, layer or section without departing from the teachings of example embodiments.

Spatially relative terms, such as “beneath,” “below,” “lower,” “above,” “upper” and the like, may be used herein for ease of description to describe one element or feature relationship to another element(s) or feature(s) as illustrated in the figures. It will be understood that the spatially relative terms are intended to encompass different orientations of the device in use or operation in addition to the orientation depicted in the figures. For example, if the device in the figures is turned over (or upside down), elements or layers described as “below” or “beneath” other elements or layers would then be oriented “above” the other elements or layers. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A voltage converter, comprising:
a power switching unit configured to receive a power voltage and a ground voltage, and configured to generate an output voltage by switching between an output terminal and one of the power voltage and the ground voltage in response to a switching signal;
an analog-digital converting unit configured to output a converted power level signal and a converted output level signal by sampling the power voltage, the output voltage, the converted power level signal and the converted output level signal corresponding to digital signals;
a digital low pass filter configured to perform low pass filtering on the converted power level signal and the converted output level signal;
an error value calculator configured to generate an error value by comparing the low pass filtered power level signal, the low pass filtered output level signal and an output set value; and
a switching signal generator configured to generate the switching signal for adjusting time interval during which the output terminal is connected to the one of the power voltage and the ground voltage.

2. The voltage converter as claimed in claim 1, wherein the error value calculator is configured to output a difference value between the output set value and a sum of a first compensation value and a second compensation value, the first compensation value corresponding to a multiplied value of the low pass filtered power level signal and a first gain factor, and the second compensation value corresponding to a multiplied value of the low pass filtered output level signal and a second gain factor.

3. The voltage converter as claimed in claim 2, wherein the error value calculator comprises:
a first multiplier configured to output the first compensation signal by multiplying the low pass filtered power level signal and the first gain factor;
a second multiplier configured to output the second compensation signal by multiplying the low pass filtered output level signal and the second gain factor; and
a subtractor configured to output the difference value between the output set value and the sum of the first compensation value and the second compensation value.

4. The voltage converter as claimed in claim 2, wherein the error value calculator is configured to output a difference value between the output set value and a sum of the first compensation value, the second compensation value and an offset value of an entire system.

5. The voltage converter as claimed in claim 4, wherein the error value calculator comprises:
a first multiplier configured to output the first compensation signal by multiplying the low pass filtered power level signal and the first gain factor;
a second multiplier configured to output the second compensation signal by multiplying the low pass filtered output level signal and the second gain factor; and
a subtractor configured to output the difference value between the output set value and the sum of the first compensation value, the second compensation value and the offset value.

6. The voltage converter as claimed in claim 4, wherein the power switching unit includes a PMOS power transistor and an NMOS power transistor serially coupled between the power voltage and the ground voltage, and gate terminals of the PMOS power transistor and the NMOS power transistor configured to receive the switching signal.

7. The voltage converter as claimed in claim 1, wherein the analog-digital converting unit includes an analog sigma delta modulator.

8. The voltage converter as claimed in claim 1, wherein the switching signal generator is configured to generate the switching signal, so that a pulse width of the switching signal is determined based on the error value.

9. The voltage converter as claimed in claim 8, wherein the switching signal generator comprises:
a digital multi-bit sigma delta modulator configured to modulate the error value into a pulse code modulation signal having a reduced number of bits; and
a pulse width modulator is configured to generate the switching signal, so that a pulse width of the switching signal is determined based on the pulse code modulation signal.

10. The voltage converter as claimed in claim 1, wherein the voltage converter is a DC-DC converter.

11. A method of converting a voltage, comprising:
generating an output voltage from a power voltage and a ground voltage by switching between an output terminal and one of the power voltage and the ground voltage in response to a switching signal;
generating a power level signal and an output level signal by sampling the power voltage and the output voltage;
performing low pass filtering on the power level signal and the output level signal;
generating an error value by comparing the low pass filtered power level signal, the low pass filtered output level signal and an output set value; and
generating the switching signal by adjusting time interval during which an output terminal is connected to one of the power voltage and the ground voltage.

12. The method as claimed in claim 11, wherein generating the error value includes outputting a difference value between the output set value and a sum of a first compensation value and a second compensation value, the first compensation value corresponding to a multiplied value of the low pass filtered power level signal and a first gain factor, and the second compensation value corresponding to a multiplied value of the low pass filtered output level signal and a second gain factor.

13. The method as claimed in claim 12, wherein generating the error value comprises:
outputting the first compensation signal by multiplying the low pass filtered power level signal and the first gain factor;
outputting the second compensation signal by multiplying the low pass filtered output level signal and the second gain factor; and
outputting the difference value between the output set value and the sum of the first compensation value and the second compensation value.

14. The method as claimed in claim 12, wherein generating the error value includes outputting a difference value between the output set value and a sum of a first compensation value, a second compensation value and an offset value of an entire system.

15. The method as claimed in claim 14, wherein generating the error value comprises:
outputting the first compensation signal by multiplying the low pass filtered power level signal and the first gain factor;
outputting the second compensation signal by multiplying the low pass filtered output level signal and the second gain factor; and
outputting the difference value between the output set value and the sum of the first compensation value, the second compensation value and the offset value of the entire system.

16. The method as claimed in claim 11, wherein generating the output voltage comprises:
providing a PMOS power transistor and an NMOS power transistor serially coupled between the power voltage and the ground voltage;
applying the switching signal to gate terminals of the PMOS power transistor and the NMOS power transistor; and
generating an output signal via a connection node of the gate terminals of the PMOS power transistor and the NMOS power transistor.

17. The method as claimed in claim 11, wherein generating the output voltage includes converting the error value by using an analog sigma delta modulator.

18. The method as claimed in claim 11, wherein generating the switching signal includes generating the switching signal by determining a pulse width of the switching signal based on the error value.

19. The method as claimed in claim 18, wherein the generating the switching signal comprises:
modulating the error value into a pulse code modulation signal having a reduced number of bits; and
generating the switching signal, so that the pulse width of the switching signal is determined based on the pulse code modulation signal.

20. The method as claimed in claim 11, wherein converting the voltage is a DC-DC conversion.
